(19) United States
(12) Patent Application Publication
(10) Pub. No.: US 2005/0063678 A1
(43) Pub. Date: Mar. 24, 2005

(54) Content reproducing apparatus and method for reproducing content

(75) Inventors: Kenya Noritomo, Osaka (JP); Masaki Yoshioka, Osaka (JP)

Correspondence Address: Jack Q. Lever, Jr.;McDERMOTT, WILL & EMERY, 600 Thirteenth Street, N.W., Washington, DC, 20005-3096, US

(73) Assignee: MATSUSHITA ELECTRIC INDUSTRIAL CO. LTD.

(21) Appl. No.: 10/914,189

(22) Filed: Aug. 10, 2004

(30) Foreign Application Priority Data
Sep. 24, 2003 (JP) 2003-331157

(51) Int. Cl. H04N 5/781; H04N 5/783

(52) U.S. Cl. 386/111; 386/112

(57) ABSTRACT

A content reproducing apparatus includes: a storage unit for storing at least one compressed decoding program; a memory unit for storing a decoding program; a control unit for supplying, to the memory unit, the decoding program read out from the storage unit; and a decoding unit for decoding content in accordance with the decoding program read out from the memory unit. Each of the compressed decoding programs is assigned a priority level. The control unit reads the compressed decoding program in order of descending priority, decompresses the program, and supplies the decompressed program to the memory unit.

### BACKGROUND OF THE INVENTION

The present invention relates to apparatus for reproducing information content such as static images, moving images, music and voice and also relates to methods for reproducing such information content.

Content such as static images, moving images, music and voice has been provided in the form of being recoded on media such as optical disks in recent years and now is also being provided as data recoded on media other than optical disks. Apparatus capable of reproducing such content provided in all forms will be hereinafter referred to as content reproducing apparatus. FIG. 12 shows a configuration of a general content reproducing apparatus and a flow of programs. In general, a content reproducing apparatus includes a decoder LSI 10, a ROM 20, a CPU 30, an SDRAM 40, and a CPU bus 101 for transmitting data among these components. As shown in FIG. 12, the content reproducing apparatus is configured as an embedded system in which memories such as the ROM 20, the CPU 30 and other components are embedded as a set. In particular, a system LSI used in a content reproducing apparatus is called a decoder LSI.

The ROM 20 stores a basic program 21, a system program 22 and a decoding program 23. The CPU 30 reads the basic program 21 and the system program 22 stored in the ROM 20, operates in accordance with these programs and, as indicated by an arrow 60, also reads the decoding program 23 into the SDRAM 40. The decoder LSI 10 reads a decoding program 43 stored in the SDRAM 40 into an internal RAM 50, thereby executing a decoding process. In general, each of the decoding programs 23 and 43 is divided among codecs. The decoder LSI 10 reads a necessary decoding program from the SDRAM 40 into the RAM 50 at appropriate timing to override the RAM 50 and executes decoding processes in accordance with the decoding program that has been read out.

In the field of content reproducing apparatus, a technique of storing the decoding program 23 in uncompressed form, i.e., executable as it is, in the ROM 20 and writing this decoding program 23 in the RAM 50 of the decoder LSI 10 immediately after power is turned on is generally adopted. FIG. 13 shows an example of arrangements of programs in the ROM 20 and the SDRAM 40 of the content reproducing apparatus shown in FIG. 12. The decoding program 23 stored in the ROM 20 is held in the SDRAM 40 without change as the decoding program 43.

For computers, a technique with which a file including one or more programs or data sets is compressed by using a compression utility and is stored in a memory, and when these programs or data sets become necessary, the stored file is decompressed by using a decompression utility so that the original programs or data sets are restored is generally adopted. This technique reduces the amount of data to be stored in the memory. In addition, a technique which reduces a necessary memory size by storing programs in compressed form is known in the fields of modems and facsimiles (see, for example, Japanese Unexamined Patent Publications Nos. 8-18623 and 5-37697).

Content reproducing apparatus is required to be compatible with media and codecs that are expected to keep on increasing in variation in future. Therefore, it is expected that content reproducing apparatus with increased number of functions is provided with larger scales of programs so that the ROM 20 needs to have its capacity increased. For example, if the ROM 20 is a Flash ROM, the Flash ROM needs a large capacity. If the ROM 20 is incorporated in the decoder LSI 10, the chip area of the decoder LSI 10 increases. These factors will increase the cost of the content reproducing apparatus. Accordingly, to reduce the apparatus cost, the necessary memory size needs to be reduced.

If the scale of programs increases as the content reproducing apparatus grows in variety, it takes more time to complete loading of decoding programs. Specifically, no content might be reproduced for a while after the power of apparatus is turned on. This impairs convenience to users, despite the increased number of functions.

### SUMMARY OF THE INVENTION

It is therefore an object of the present invention to reduce the memory size necessary for particularly storing decoding programs in particular in a content reproducing apparatus. It is another object of the present invention to allow the content reproducing apparatus to reproduce content more quickly after the power is turned on.

In order to achieve these objects, according to the present invention, a content reproducing apparatus capable of reproducing content in one or more encoded formats includes: a storage unit for storing one or more decoding programs for respectively decoding the content in one or more encoded formats; a memory unit for storing a decoding program; a control unit for reading, from the storage unit, a decoding program for decoding given content provided to the content reproducing apparatus and for supplying the decoding program to the memory unit; and a decoding unit for reading the decoding program for decoding the given content from the memory unit, and for decoding the given content in accordance with the decoding program which has been read out. The storage unit stores in compressed form one or more of the decoding programs. If the control unit reads a compressed decoding program from the storage unit, the control unit decompresses the compressed decoding program and supplies the decompressed decoding program to the memory unit.

With this apparatus, at least one compressed decoding program is stored in the storage unit, is read out as necessary by the control unit and is decompressed. The decoding program is required to be executed immediately after startup of the system. Accordingly, even if the decoding program is stored in compressed form, the startup speed of the content reproducing apparatus does not slow down. As a result, the storage unit of the content reproducing apparatus is allowed to have a relatively small memory size.

Specifically, the storage unit stores a decompressing program for decompressing the compressed decoding program, and the control unit reads the decompressing program from the storage unit and decompresses the compressed decoding program read out from the storage unit, in accordance with the decompressing program.

It is preferable that the storage unit stores in compressed form a decoding program used with a relatively low frequency, and stores in uncompressed form a decoding program used with a relatively high frequency.

Then, the decoding program used with a relatively low frequency is stored in compressed form, so that the necessary memory size is relatively small. On the other hand, the decoding program used with a relatively high frequency is stored in uncompressed form, thus achieving a quick startup. If a decoding program for achieving size reduction and a program for shortening the startup time are adjusted, a content reproducing apparatus in which the necessary memory size and the startup time are well balanced.

It is preferable that each of the compressed decoding programs stored in the storage unit is assigned a priority level, and the control unit reads the compressed decoding programs in order of descending priority.

Then, compressed decoding programs are read out from the storage unit and decompressed, in order of descending priority. Accordingly, the necessary time from when the power is turned on to when reproduction of content is allowed is optimized according to specifications of the content reproducing apparatus.

It is preferable that the control unit refers to decompression-information indicating whether each said compressed decoding program stored in the storage unit has been already decompressed or not and, if the decoding program for decoding the given content has been already decompressed, the control unit neither reads nor decompresses the decoding program.

Then, an unnecessary process such as additional decompression does not need to be performed on a decoding program which has been already decompressed.

The inventive apparatus preferably further includes a recording medium identifying unit for identifying the type of a recording medium on which given content to be provided to the content reproducing apparatus is recorded, and the control unit preferably reads a decoding program for decoding the given content out of at least one decoding program which is included in the one or more decoding programs stored in the storage unit and is associated with the recording medium whose type is identified by the recording medium identifying unit.

Then, decoding programs to be read out by the control unit are narrowed down based on information on the type of the recording medium identified by the recording medium identifying unit. That is, all the decoding programs are not necessarily read out. Accordingly, the time from the insertion of the recording medium to the reproduction of content is shortened.

It is further preferable that the recording medium identifying unit reads, from the recording medium, management-information containing information on each encoding format of content recorded on the recording medium, and the control unit reads a decoding program for decoding the given content out of at least one decoding program which is included in the one or more decoding programs stored in the storage unit and is associated with the content recorded on the recording medium, based on the management-information.

Then, decoding programs to be read out by the control unit are further narrowed down based on management-information read out by the recording medium identifying unit. Accordingly, the time required before the reproduction of content is further shortened.

According to the present invention, a method for reproducing content in one or more encoded formats includes: a program reading step of reading a decoding program for decoding given content out of one or more decoding programs for respectively decoding the content in one or more encoded formats; a decompression step of, if the decoding program read out in the program reading step is compressed, decompressing the compressed decoding program; and a decoding step of decoding the given content in accordance with the decoding program decompressed in the decompression step.

With this method, a compressed decoding program read out in the program reading step is decompressed in the decompression step. The decompressed decoding program is executed in the decoding step so that given content is decoded. That is, the decoding program is stored in compressed form, so that a relatively small necessary memory size is sufficient.

Specifically, the decompression step is performed in accordance with a decompressing program, and the inventive method further includes a decompressing program reading step of reading the decompressing program.

It is preferable that out of decoding programs to be read out in the program reading step, a decoding program used with a relatively low frequency is compressed whereas a decoding program used with a relatively high frequency is not compressed.

Then, the decoding program used with a relatively low frequency is compressed, so that the necessary memory size is relatively small. On the other hand, the decoding program used with a relatively high frequency is stored in uncompressed form, thus achieving a quick startup. If a decoding program for achieving size reduction and a program for shortening the startup time are adjusted, a method for reproducing content with which the necessary memory size and startup time are well balanced is obtained.

It is preferable that compressed decoding programs to be read out in the program reading step are respectively assigned priority levels, and the compressed decoding programs are read out in order of descending priority in the program reading step.

Then, compressed decoding programs are read out and decompressed in order of descending priority. Accordingly, the time required before the reproduction of content is optimized.

The inventive method preferably further includes a determination step of determining whether a compressed decoding program to be read out in the program reading step has been decompressed or not, and if the compressed decoding program to be read out is determined to have been already decompressed in the determination step, the decoding program is preferably not read out in the program reading step.

Then, an unnecessary process such as additional decompression does not need to be performed on a decoding program which has been already decompressed.

The inventive method preferably further includes a recording medium identifying step of identifying the type of a recording medium on which content to be decoded in the decoding step is recorded, and in the program reading step, a decoding program for decoding the given content out of at least one decoding program which is included in the one or more decoding programs and is associated with the recording medium whose type is identified in the recording medium identifying step is preferably read out.

Then, decoding programs to be read out in the program reading step are narrowed down based on information on the type of the recording medium identified in the recording medium identifying step. That is, all the decoding programs are not necessarily read out. Accordingly, the time required from the insertion of the recording medium to the reproduction of content is shortened.

It is more preferable that the inventive method further includes a management-information reading step of reading, from the recording medium, management-information containing information on each encoded format of content recorded on the recording medium, wherein in the program reading step, a decoding program for decoding the given content out of at least one decoding program which is included in the one or more decoding programs and is associated with the content recorded on the recording medium is read out based on the management-information read out in the management-information reading step.

Then, decoding programs to be read out in the program reading step are further narrowed down based on management-information read out in the management-information reading step. Accordingly, the time required before the reproduction of content is further shortened.

As described above, according to the present invention, the necessary memory size for storing decoding programs in a content reproducing apparatus is reduced. Accordingly, the cost for fabricating the apparatus is reduced. In addition, decoding programs stored in compressed form are decompressed in sequence beginning with a program used with the highest frequency, so that a quick startup is achieved with the necessary memory size of the content reproducing apparatus reduced.

### BRIEF DESCRIPTION OF THE DRAWINGS

FIG. 1 is a diagram showing a configuration of a content reproducing apparatus according to a preferred embodiment of the present invention.

FIG. 2 is a diagram showing an example of arrangement of programs in a content reproducing apparatus according to a first embodiment of the present invention.

FIG. 3 is a flowchart showing a method for reproducing content according to the first embodiment.

FIG. 4 is a diagram showing an example of arrangement of programs in a content reproducing apparatus according to a second embodiment of the present invention.

FIG. 5 is a management table for decoding programs.

FIG. 6 is a flowchart showing a method for reproducing content according to the second embodiment.

FIG. 7 is a flowchart showing a method for reproducing content according to a third embodiment of the present invention.

FIG. 8 is a flowchart showing a method for reproducing content according to a fourth embodiment of the present invention.

FIG. 9 is a flowchart showing a method for reproducing content according to a fifth embodiment of the present invention.

FIG. 10 is an illustration schematically showing a file system on a medium.

FIG. 11 is a flowchart showing a method for reproducing content according to a sixth embodiment of the present invention.

FIG. 12 is a diagram showing a configuration of a general content reproducing apparatus and a flow of programs.

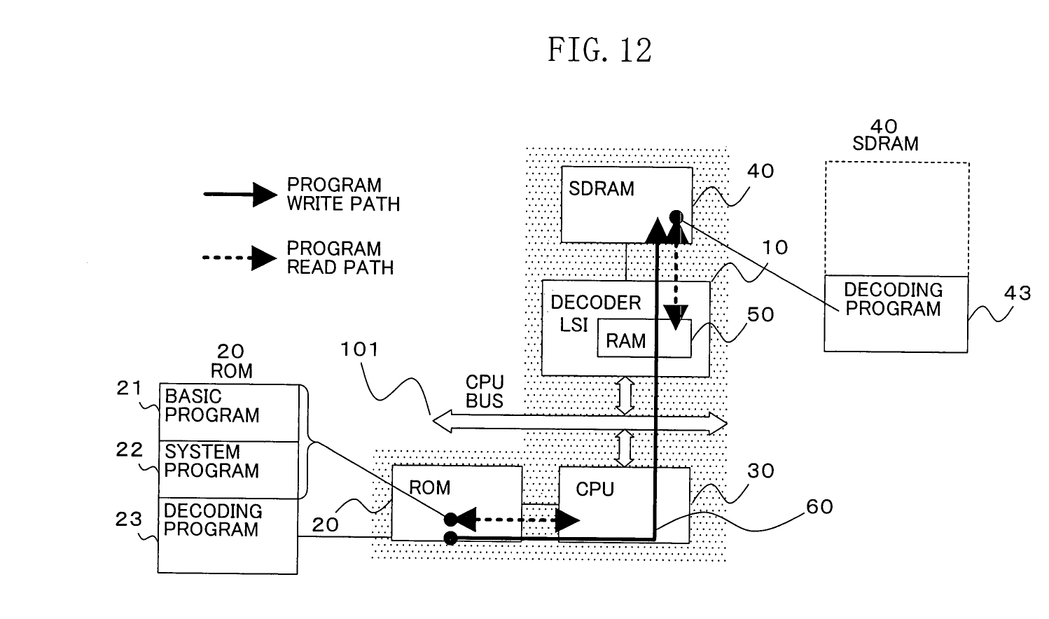

FIG. 13 is a diagram showing an example of arrangement of programs in the general content reproducing apparatus.

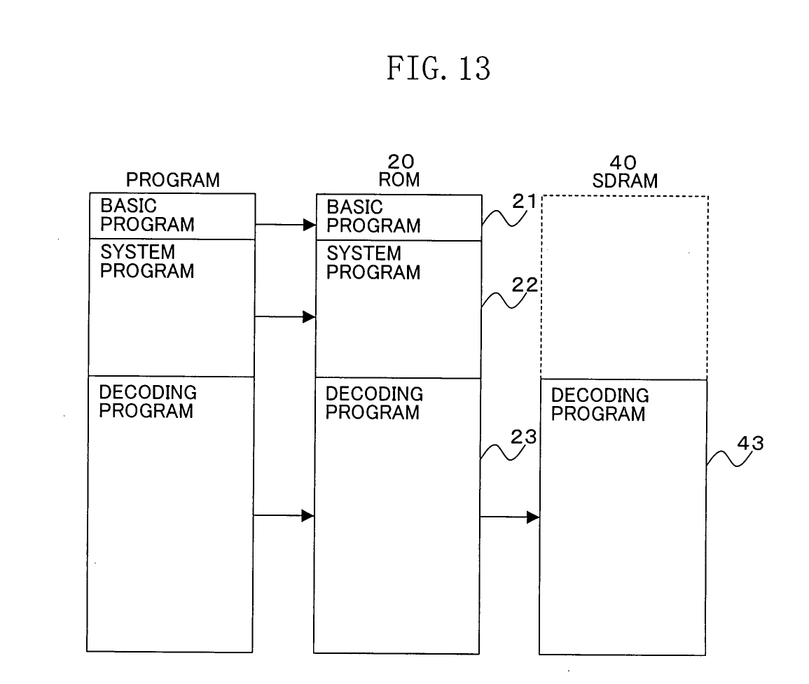

### DESCRIPTION OF THE PREFERRED EMBODIMENTS

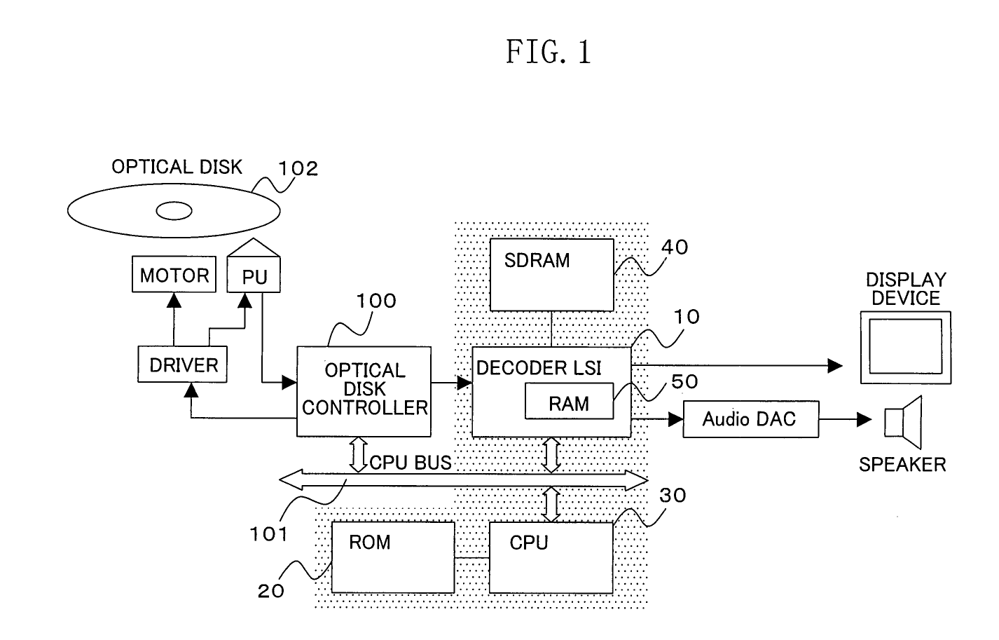

FIG. 1 shows a configuration of a content reproducing apparatus according to a preferred embodiment of the present invention. A CPU 30 as a control unit reads one or more decoding programs stored in a ROM 20 as a storage unit and loads the decoding programs into a given area of an SDRAM 40 as a memory unit. A decoder LSI 10 as a decoding unit reads one of the decoding programs loaded into the SDRAM 40 into a RAM 50 and executes the program. Accordingly, the decoder LSI 10 becomes capable of reproducing content. The CPU 30 controls an optical disk controller 100 via a CPU bus 101 and reads data from an optical disk 102. Then, this data is decoded by the decoder LSI 10 and output, as a video or audio signal, to an external display device or a speaker.

Hereinafter, examples of decoding program arrangements and examples of reading decoding programs in the content reproducing apparatus shown in FIG. 1 will be described as embodiments of the present invention.

Embodiment 1

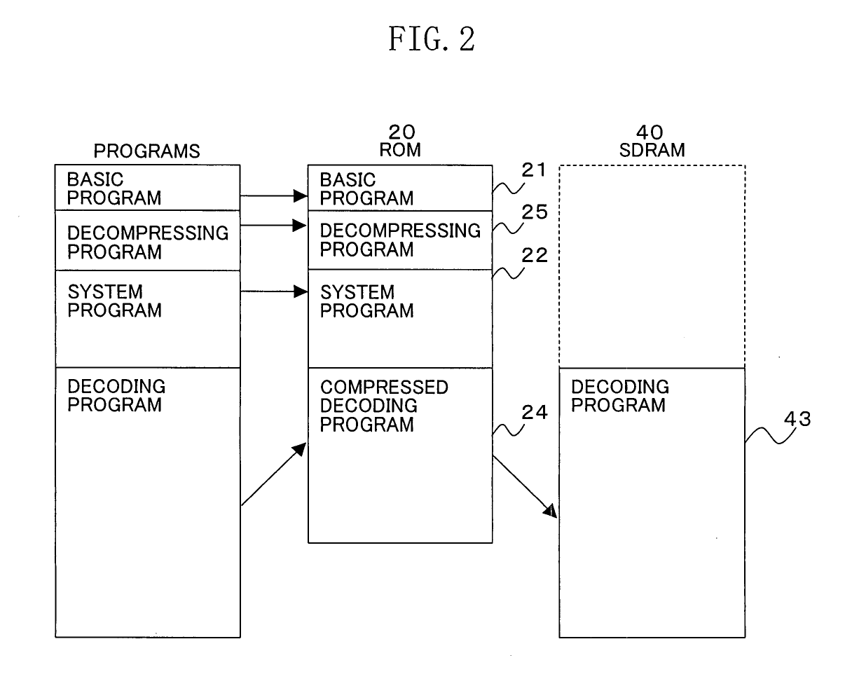

FIG. 2 shows an example of arrangements of programs in a ROM 20 and an SDRAM 40 in a content reproducing apparatus according to a first embodiment of the present invention. The ROM 20 stores a basic program 21, a decompressing program 25, a system program 22 and a compressed decoding program 24. A CPU 30 reads and executes the basic program 21, the system program 22 and the decompressing program 25. The CPU 30 reads the compressed decoding program 24 and decompresses the program in accordance with the decompressing program 25. Then, the CPU 30 loads a decoding program 43 executable by the decoder LSI 10 into the SDRAM 40. The decoding program 24 is compressed, containing one or more decoding programs as one block. In other words, the decoding program 24 is not divided into blocks.

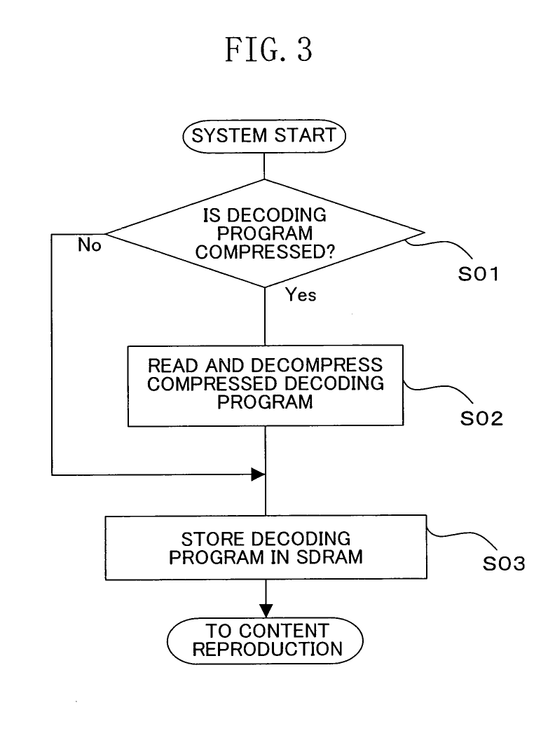

FIG. 3 is a flowchart showing a method for reproducing content according to this embodiment. Hereinafter, operation of the content reproducing apparatus of this embodiment will be described with reference to the flowchart shown in FIG. 3. First, after the power has been turned on, the CPU 30 reads a basic program from the ROM 20 and executes the program. This allows the decoder LSI 10 to access the SDRAM 40. Then, the CPU 30 determines whether a compressed decoding program is stored in the ROM 20 or not (step S01). At step S01, if the determination result is Yes, the CPU 30 reads a decompressing program from the ROM 20 and decompresses the compressed decoding program (step S02). Specifically, the CPU 30 reads a compressed decoding program from the ROM 20 (i.e., a program reading step) and decompresses the compressed decoding program which has been read out (i.e., decompression step). Thereafter, the decoding program is stored in a given area of the SDRAM 40 (step S03). If the result is No at step S01, the process proceeds to step S03.

After the decoding program has been stored in the given area of the SDRAM 40, the decoder LSI 10 decodes content recorded on the optical disk 102 (i.e., decoding step), thereby reproducing the content such as a wallpaper to be displayed on a TV screen, e.g., displaying an opening image or reproducing DVD-Video data.

As described above, in this embodiment, a compressed decoding program is stored in the ROM 20, so that the necessary memory size is smaller than that in conventional apparatus. Accordingly, the cost of the content reproducing apparatus is reduced.

Embodiment 2

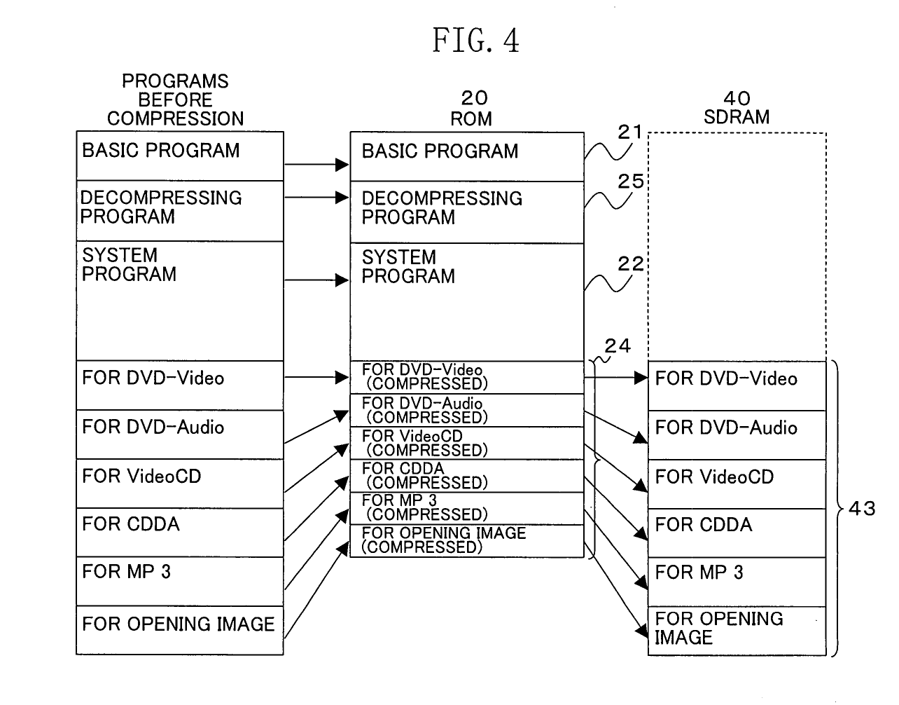

FIG. 4 shows an example of arrangements of programs in a ROM 20 and an SDRAM 40 in a content reproducing apparatus according to a second embodiment of the present invention. The second embodiment is different from the first embodiment in that a decoding program is divided among the types of media on which content to be reproduced is recorded. Specifically, as shown in FIG. 4, a decoding program 24 is stored, being divided into programs for DVD-Video, DVD-Audio, VideoCD, CDDA, MP3, an opening image, and others, respectively. The divided decoding programs are individually loaded into the SDRAM 40. More specifically, each of the decoding programs divided among the types of media is constituted by one or more blocks each serving as a minimum program unit. Each of these blocks is stored in the ROM 20 in compressed or uncompressed form. All the divided decoding programs are not necessarily loaded into the SDRAM 40 and it is sufficient that necessary programs out of these decoding programs are loaded into the SDRAM 40 at appropriate timing.

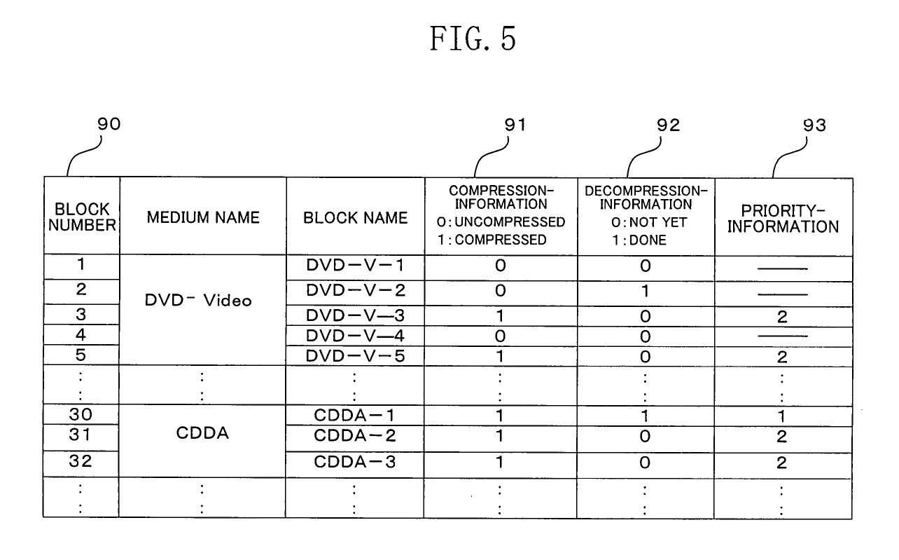

FIG. 5 is a management table for decoding programs. Each block is assigned a block number 90, and compression-information 91 is recorded for each block. That is, if the compression-information 91 is referred to, it is shown whether a given block is stored in compressed form or not.

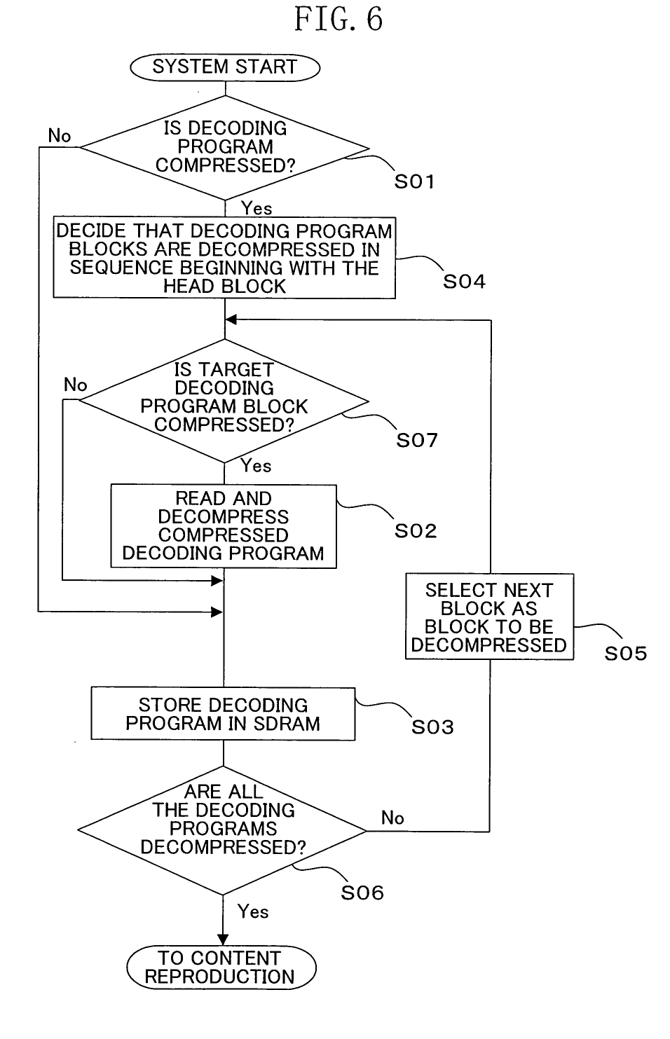

FIG. 6 is a flowchart showing a method for reproducing content according to this embodiment. Hereinafter, operation of the content reproducing apparatus of this embodiment will be described with reference to the flowchart shown in FIG. 6. Steps S01, S02 and S03 are the same as those described in the first embodiment, and thus description thereof will be hereinafter omitted. If the result is Yes at step S01, the CPU 30 decides that decoding program blocks stored in the ROM 20 are decompressed in sequence beginning with the head block (step S04). Then, the CPU 30 refers to the compression-information 91 in the management table and determines whether a target block is compressed or not (step S07). If the determination result is No at step S07, the process proceeds to step S03, and then the CPU 30 determines whether all the blocks of the decoding programs are decompressed or not (step S06). If the determination result is Yes at step S06, content reproduction is initiated. If the result is No at step S06, the next block is selected as a block to be decompressed (step S05), and the process returns to step S07. On the other hand, if the result is No at step S01, the process proceeds to step S03, and then content reproduction is initiated. The blocks decompressed at step S02 are read into the decoder LSI 10 and executed by the decoder LSI 10 as necessary.

As described above, in this embodiment, a decoding program is divided and these divided blocks are stored, so that each of the divided decoding programs is compressed or uncompressed in accordance with specifications of configuration of the content reproducing apparatus. For example, a decoding program used with a relatively high frequency is stored in uncompressed form whereas a decoding program used with a relatively low frequency is stored in compressed form. Accordingly, loading of the frequently-used decoding program is completed in a relatively short time so that the content reproducing apparatus starts operating quickly. On the other hand, the program used with a low frequency has a reduced necessary memory size. As a result, content reproducing apparatus capable of starting its operation quickly with the necessary memory size reduced is achieved.

The management table may be provided in the ROM 20 or may be provided in another memory.

Embodiment 3

A content reproducing apparatus according to a third embodiment of the present invention deals with decoding programs assigned priority levels. In the management table shown in FIG. 5, each block in compressed form is assigned priority-information 93. The content reproducing apparatus of this embodiment decompresses decoding programs in order of descending priority.

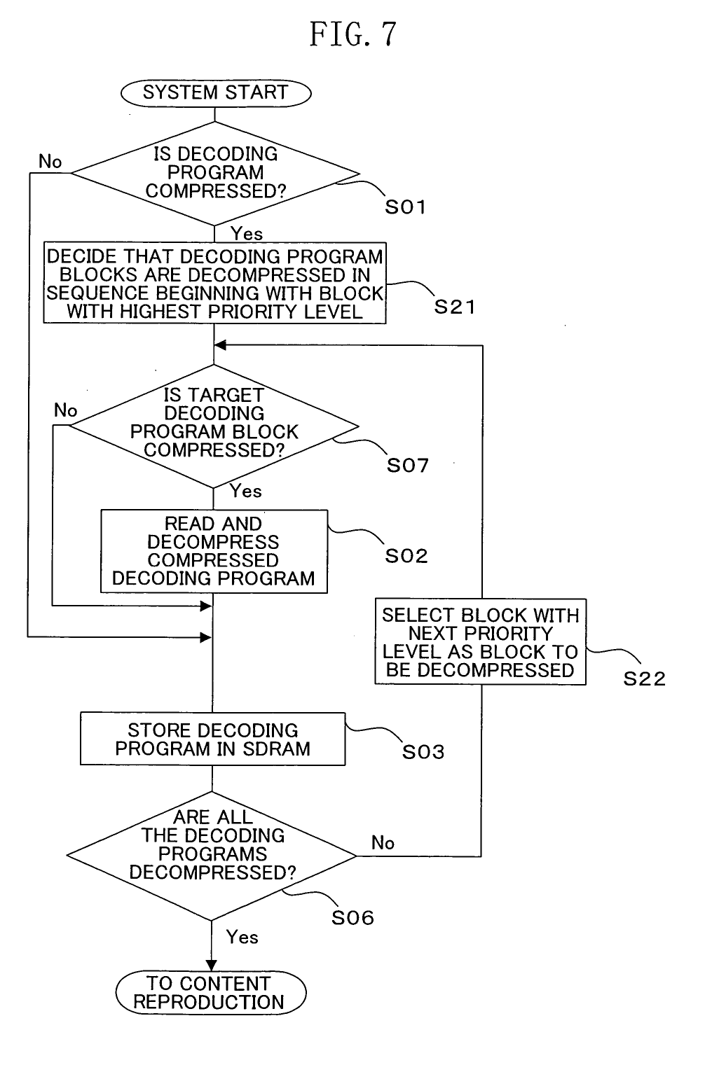

FIG. 7 is a flowchart showing a method for reproducing content according to this embodiment. In the flowchart shown in FIG. 7, steps S04 and S05 included in the flowchart shown in FIG. 6 are replaced with steps S21 and S22, respectively. Hereinafter, steps S21 and S22 will be described. If the result is Yes at step S01, a CPU 30 decides that decoding programs stored in a ROM 20 are decompressed in sequence beginning with a block with the highest priority level (step S21). Specifically, the CPU 30 recognizes the priority level of each program block in compressed form by referring to the priority-information 93 in the management table. If the result is No at step S06, a program block with the second highest priority level is selected as a block to be decompressed (step S22).

As described above, in this embodiment, compressed decoding programs are decompressed in order of descending priority, so that the startup of the content reproducing apparatus is optimized in accordance with specifications of the configuration of the content reproducing apparatus.

Embodiment 4

A content reproducing apparatus according to a fourth embodiment of the present invention stores information on decompressed decoding programs. In the management table shown in FIG. 5, decompression-information 92 is recorded for each block in compressed form. In the content reproducing apparatus of this embodiment, decompression of an already-decompressed decoding program is not performed.

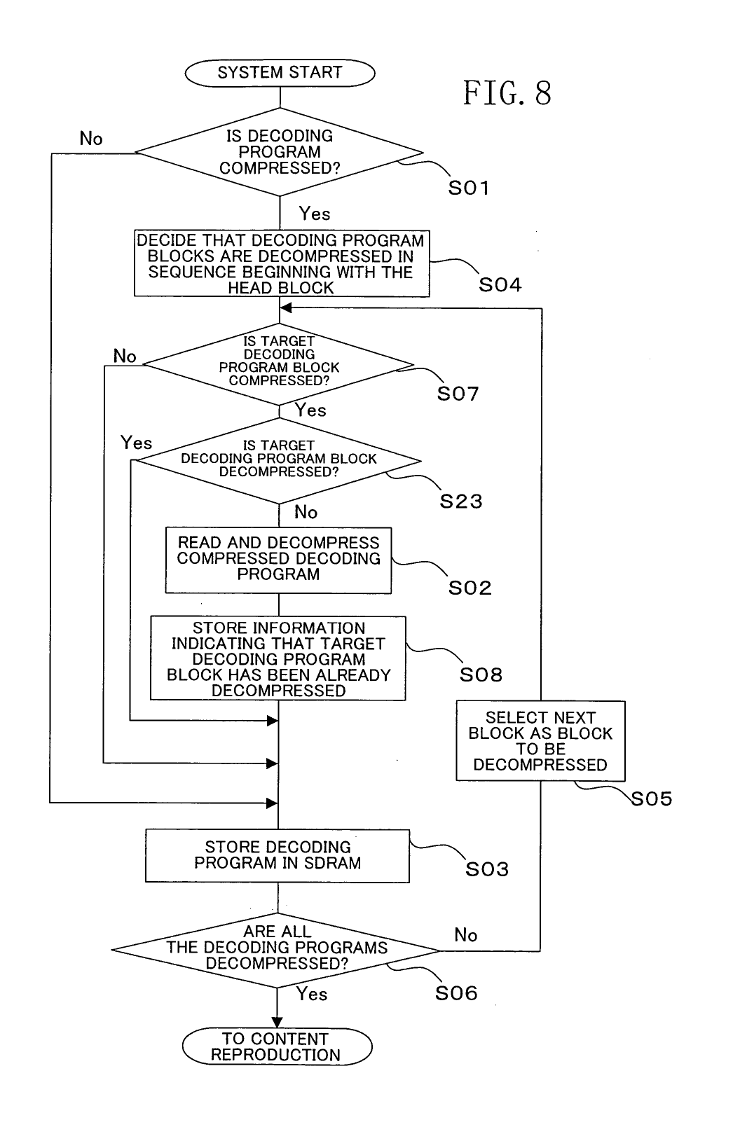

FIG. 8 is a flowchart showing a method for reproducing content according to this embodiment. In the flowchart shown in FIG. 8, steps S23 and S08 are respectively added before and after step S02 in the flowchart shown in FIG. 6. Hereinafter, step S23 and S08 will be described. If the result is Yes at step S07, a CPU 30 refers to the decompression-information 92 in the management table and determines whether a target block has been decompressed or not (i.e., a determination step) (step S23). If the result is No at step S23, the process proceeds to step S02, and then information indicating that the target block has been already decompressed is stored in the management table (step S08). If the result is Yes at step S23, the process skips steps S02 and S08 and proceeds to step S03.

As described above, in this embodiment, a decoding program which has been once decompressed is not decompressed again, i.e., unnecessary decompression is not performed, unless the power is turned on again, for example. Accordingly, in a case where content in various encoded formats are reproduced one after another, the time required for again reproducing content in an encoded format which has been once reproduced is shortened.

Embodiment 5

A content reproducing apparatus according to a fifth embodiment of the present invention narrows compressed decoding programs stored in a ROM 20 down to programs which can be a target of readout. Specifically, the content reproducing apparatus of this embodiment uses the optical disk controller 100 shown in FIG. 1 as a recording medium identifying unit to narrow down the decoding programs based on an identification result on the type of an optical disk 102 obtained by the optical disk controller 100.

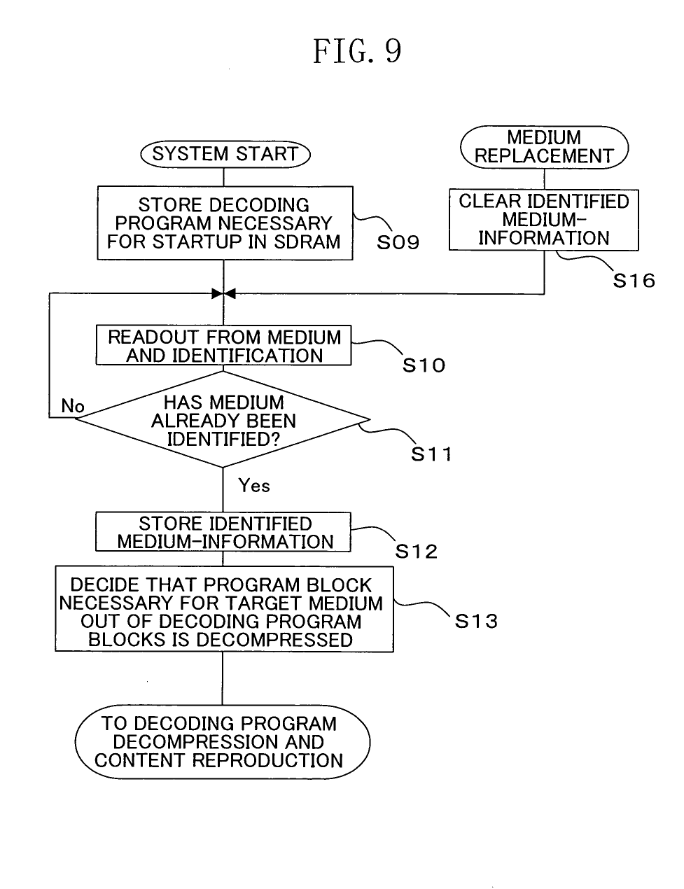

FIG. 9 is a flowchart showing a method for reproducing content according to this embodiment. Hereinafter, operation of the content reproducing apparatus of this embodiment will be described with reference to the flowchart shown in FIG. 9. First, after the power has been turned on, a CPU 30 reads and executes a basic program. This allows a decoder LSI 10 to access an SDRAM 40. Thereafter, the CPU 30 reads a decoding program necessary for startup, e.g., a decoding program for an opening image, from the ROM 20 and stores the program in a given area of the SDRAM 40 (step S09). Then, the optical disk controller 100 reads data from the optical disk 102 and identifies the type of the medium (i.e., a recording medium identifying step) (step S10). The optical disk controller 100 repeatedly performs step S10 until this medium identification terminates. After the medium identification, the optical disk controller 100 stores medium-information in a given recording area (step S12). The CPU 30 refers to the medium-information and determines a block necessary for reproduction from the medium whose type has been identified by the optical disk controller 100 (step S13). Subsequently, decompression and content reproduction are performed on decoding programs which have been narrowed down at step S13, in a similar manner as in the second, third or fourth embodiment.

If the medium is replaced with another medium, the optical disk controller 100 clears the medium-information identified before the replacement (step S16). Then, the process proceeds to step S10. In the case of decompression of decoding programs performed in a similar manner as in the fourth embodiment, a decoding program which has been decompressed before the medium replacement is held in the SDRAM 40, so that this decoding program does not need to be decompressed.

As described above, compressed decoding programs stored in the ROM 20 are narrowed down to programs which can be a target of readout, thus shortening the time from the insertion of a medium to the reproduction of content.

The medium-information may be stored in the SDRAM 40 or in another rewritable memory.

Embodiment 6

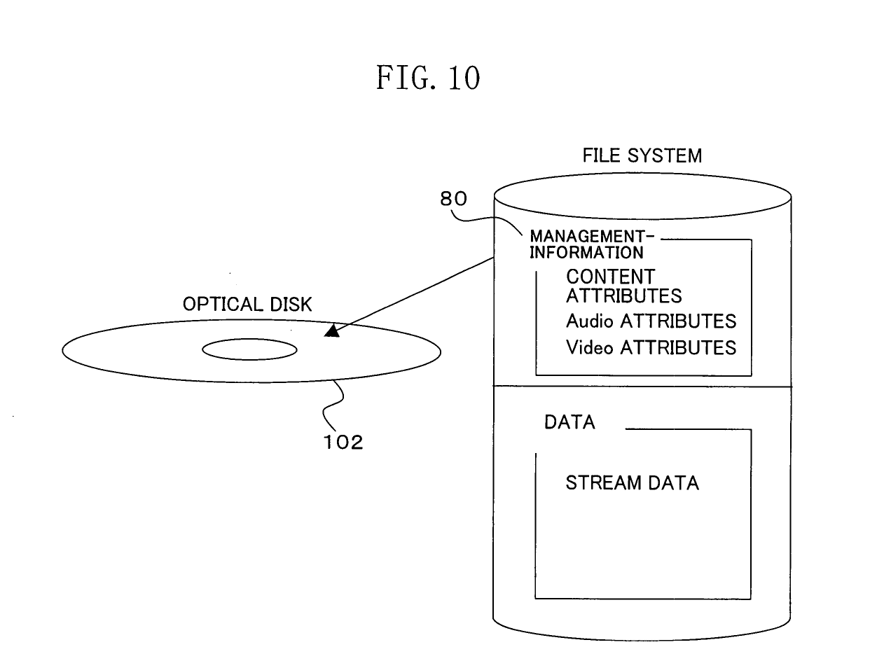

FIG. 10 schematically shows a file system on a medium. A file system on an optical disk 102 generally contains management-information 80, which is information regarding attributes of content such as Audio attributes and Video attributes. A content reproducing apparatus according to a sixth embodiment of the present invention further narrows compressed decoding programs down to programs which can be a target of readout, based on the management-information 80.

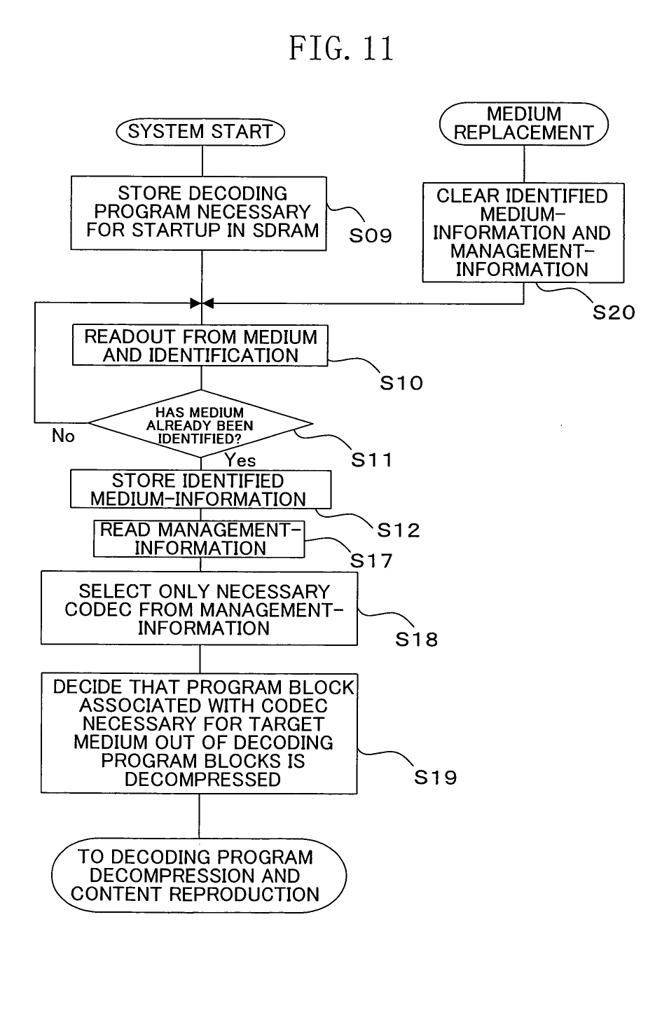

FIG. 11 is a flowchart showing a method for reproducing content according to this embodiment. Hereinafter, operation of the content reproducing apparatus of this embodiment will be described with reference to the flowchart shown in FIG. 11. Steps S09 through S12 are the same as those described in the fifth embodiment, and thus description thereof will be hereinafter omitted. After step S12, an optical disk controller 100 reads the management-information 80 from the optical disk 102 (i.e., a management-information reading step) (step S17). A CPU 30 refers to the management-information 80 and selects a block number of a decoding program associated with a codec necessary for reproducing content recorded on an inserted disk (step S18). Then, the CPU 30 decides that one or more blocks selected at step S18 are decoding programs to be read out (step S19). Thereafter, decompression and content reproduction are performed on decoding programs which have been narrowed down at step S19, in a similar manner as in the second, third or fourth embodiment.

If the medium is replaced with another medium, the optical disk controller 100 clears the medium-information identified before the replacement and the management-information which has been read out (step S20). Then, the process proceeds to step S10.

As described above, compressed decoding programs are narrowed down to programs which can be a target of readout, thus further shortening the time from the insertion of a medium to the reproduction of content, as compared to the fifth embodiment.

The management-information may be stored in an SDRAM 40 or in another rewritable memory.

In the foregoing embodiments, the decoder LSI 10 may decompress compressed decoding programs. In such a case, a decompressing program for the decoder LSI 10 is stored in the ROM 20 such that this program is read out and executed by the decoder LSI 10.

In the foregoing embodiments, content is read out from the optical disk 102. However, the present invention is not limited to these specific embodiments. Content may be input from a recoding medium other than the optical disk 102, or may be input via a network.

### INDUSTRIAL APPLICABILITY

Accordingly, a content reproducing apparatus according to the present invention is useful as an apparatus for reproducing content recorded on various recording media. For example, the inventive apparatus is applicable as an apparatus for reproducing content data recorded on a memory card such as an SD card™ or a PC card. If broadcast data is dealt with as content, the inventive apparatus is applicable as a content reproducing apparatus for reproducing content via a medium other than a recording medium or an information infrastructure.

1. A content reproducing apparatus capable of reproducing content in one or more encoded formats, the apparatus comprising:
a storage unit for storing one or more decoding programs for respectively decoding the content in one or more encoded formats;
a memory unit for storing a decoding program;
a control unit for reading, from the storage unit, a decoding program for decoding given content provided to the content reproducing apparatus and for supplying the decoding program to the memory unit; and
a decoding unit for reading the decoding program for decoding the given content from the memory unit, and for decoding the given content in accordance with the decoding program which has been read out,
wherein the storage unit stores in compressed form one or more of the decoding programs, and
if the control unit reads a compressed decoding program from the storage unit, the control unit decompresses the compressed decoding program and supplies the decompressed decoding program to the memory unit.

2. The apparatus of claim 1, wherein the storage unit stores a decompressing program for decompressing the compressed decoding program, and
the control unit reads the decompressing program from the storage unit and decompresses the compressed decoding program read out from the storage unit, in accordance with the decompressing program.

3. The apparatus of claim 1, wherein the storage unit stores in compressed form a decoding program used with a relatively low frequency, and stores in uncompressed form a decoding program used with a relatively high frequency.

4. The apparatus of claim 1, wherein each of the compressed decoding programs stored in the storage unit is assigned a priority level, and
the control unit reads the compressed decoding programs in order of descending priority.

5. The apparatus of claim 1, wherein the control unit refers to decompression-information indicating whether each said compressed decoding program stored in the storage unit has been already decompressed or not and, if the decoding program for decoding the given content has been already decompressed, the control unit neither reads nor decompresses the decoding program.

6. The apparatus of claim 1, further comprising a recording medium identifying unit for identifying the type of a recording medium on which given content to be provided to the content reproducing apparatus is recorded,
wherein the control unit reads a decoding program for decoding the given content out of at least one decoding program which is included in the one or more decoding programs stored in the storage unit and is associated with the recording medium whose type is identified by the recording medium identifying unit.

7. The apparatus of claim 6, wherein the recording medium identifying unit reads, from the recording medium, management-information containing information on each encoding format of content recorded on the recording medium, and
the control unit reads a decoding program for decoding the given content out of at least one decoding program which is included in the one or more decoding programs stored in the storage unit and is associated with the content recorded on the recording medium, based on the management-information.

8. A method for reproducing content in one or more encoded formats,
the method comprising:
a program reading step of reading a decoding program for decoding given content out of one or more decoding programs for respectively decoding the content in one or more encoded formats;
a decompression step of, if the decoding program read out in the program reading step is compressed, decompressing the compressed decoding program; and
a decoding step of decoding the given content in accordance with the decoding program decompressed in the decompression step.

9. The method of claim 8, wherein the decompression step is performed in accordance with a decompressing program, and
the method further comprises a decompressing program reading step of reading the decompressing program.

10. The method of claim 8, wherein out of decoding programs to be read out in the program reading step, a decoding program used with a relatively low frequency is compressed whereas a decoding program used with a relatively high frequency is not compressed.

11. The method of claim 8, wherein compressed decoding programs to be read out in the program reading step are respectively assigned priority levels, and
the compressed decoding programs are read out in order of descending priority in the program reading step.

12. The method of claim 8, further comprising a determination step of determining whether a compressed decoding program to be read out in the program reading step has been decompressed or not,
wherein if the compressed decoding program to be read out is determined to have been already decompressed in the determination step, the decoding program is not read out in the program reading step.

13. The method of claim 8, further comprising a recording medium identifying step of identifying the type of a recording medium on which content to be decoded in the decoding step is recorded,
wherein in the program reading step, a decoding program for decoding the given content out of at least one decoding program which is included in the one or more decoding programs and is associated with the recording medium whose type is identified in the recording medium identifying step is read out.

14. The method of claim 13, further comprising a management-information reading step of reading, from the recording medium, management-information containing information on each encoded format of content recorded on the recording medium,
wherein in the program reading step, a decoding program for decoding the given content out of at least one decoding program which is included in the one or more decoding programs and is associated with the content recorded on the recording medium is read out based on the management-information read out in the management-information reading step.
